(19) United States
(12) Patent Application Publication
(10) Pub. No.: US 2021/0133534 A1
(43) Pub. Date: May 6, 2021

(54) CLOUD TASK SCHEDULING METHOD BASED ON PHAGOCYTOSIS-BASED HYBRID PARTICLE SWARM OPTIMIZATION AND GENETIC ALGORITHM

(71) Applicant: INNER MONGOLIA AGRICULTURAL UNIVERSITY, Inner Mongolia Autonomous Region (CN)

(72) Inventors: Xueliang FU, Huhehaote (CN); Yang SUN, Huhehaote (CN); Honghui LI, Huhehaote (CN)

(21) Appl. No.: 17/020,118

(22) Filed: Sep. 14, 2020

(30) Foreign Application Priority Data
Oct. 30, 2019 (CN) 201911047136.7

(51) Int. Cl. G06N 3/00; G06F 9/50; G06N 3/12; G06F 9/455

(52) U.S. Cl. CPC G06N 3/006; G06F 9/5072; G06F 2009/4557; G06F 9/5083; G06F 9/45558; G06N 3/126

(57) ABSTRACT

The invention discloses a cloud task scheduling method based on phagocytosis-based Hybrid Particle Swarm Optimization and Genetic Algorithm (HPSOGA). In response to the task scheduling problem in cloud environment, update manners of position and speed in a standard particle swarm optimization are changed; a fitness function and a load balancing standard deviation are used to perform primary division and secondary division on particles in each generation of a particle swarm; and phagocytosis mutation and crossover mutation are respectively performed on different particle subpopulations obtained after division, so that a cloud task scheduling scheme is obtained. The method provided in the present invention obviously reduces total completion time of cloud tasks, and is of higher convergence accuracy. Therefore, the cloud task scheduling method based on phagocytosis-based hybrid of particle swarm optimization and genetic algorithm provided in the present invention proves to be effective.

### RELATED APPLICATIONS

This application is based on and claims benefit of and priority to CN Patent Application No. 201911047136.7 filed on Oct. 30, 2019.

### TECHNICAL FIELD

The present invention relates to the field of cloud technology, and in particular, to a cloud task scheduling method based on phagocytosis-based Hybrid Particle Swarm Optimization and Genetic Algorithm (HP SOGA).

### BACKGROUND

Cloud computing is defined as an information technology and a delivery model for achieving convenient, on-demand network access to a shared pool of configurable computing resources (such as a network, a server, a storage, an application, and a service), and may be quickly provided and released through minimized management or interaction between service providers. The delivery model of cloud computing mainly falls into software as a service (SaaS), platform as a service (PaaS) and infrastructure as a service (IaaS).

As an emerging technology, cloud computing is widely used by enterprises due to its great commercial value. The technology can reasonably use and allocate various resources provided by the cloud environment, effectively schedule massive tasks submitted by users, and ensure load balancing of cloud systems, which is of great significance for increasing core competitiveness of enterprises and improving their economic efficiency. With the widespread application of cloud computing, there is an increasing quantity of cloud users and cloud tasks, so that the cloud environment faces severe challenges. How to reasonably use and allocate various resources provided by the cloud environment, how to effectively schedule massive tasks submitted by users and ensure load balancing of cloud systems have become hot spots in the field of cloud computing research. Even in some simple cases, achieving optimal scheduling and allocation of a cloud task is a non-deterministic polynomial (NP) complete problem. Because in this type, we cannot get a solution in polynomial time. In a cloud computing environment, a large quantity of users need resources at the same time, so the scheduling method should be determined as soon as possible. To solve the task scheduling problem in the cloud environment, researchers at home and abroad have proposed a plurality of non-heuristic algorithms and heuristic algorithms. For example, Max-Min algorithm and Min-Min algorithm are common non-heuristic algorithms, and particle swarm optimization and genetic algorithm are common heuristic algorithms. Gradually, task scheduling algorithms, especially heuristic algorithms in the cloud computing environment are widely used since they become more mature. Then various intelligent scheduling algorithms based on improved optimization heuristics appeared. Some of these algorithms are as follows: the improved genetic algorithm (IGA) proposed in “Cloud task scheduling algorithm based on improved genetic algorithm”, which introduces, based on genetic algorithm (GA), a “three-stage selection method” and similarity of crossover domain to reduce the possibility of the genetic algorithm falling into the local optimal solution; the improved particle swarm optimization (IPSO) proposed in “Research on cloud computing task scheduling algorithm based on particle swarm optimization”, which introduces adaptive inertia weights and random factors into the standard particle swarm optimization to enable the particle swarm optimization less prone to fall into the local optimal solution and improve its search capability; the slave ants based ant colony optimization (SACO) proposed in “A slave ants based ant colony optimization algorithm for task scheduling in cloud computing environments”, which uses optimized parameter mapping to efficiently schedule cloud user tasks to virtual machines (VM) in cloud computing environments and solves the global optimization problem of slave ants by avoiding a long path which is selected by the ants due to erroneous accumulation of pheromones; and the multiobjective discrete artificial bee colony (MDABC) algorithm proposed in “Optimization of cloud task scheduling based on discrete artificial bee colony algorithm”, which improves the search mechanism of the neighborhood solution and adds a local search operator to improve efficiency and balance of cloud computing processing tasks.

According to the “no free lunch” principle, no algorithm can fully satisfy all application scenarios, and only “the effect of an algorithm under specific conditions is the best”. Therefore, when a single algorithm cannot fully solve a task scheduling problem, it is better to try a new one.

### SUMMARY

In response to the above problems, the present invention aims to provide a cloud task scheduling method based on phagocytosis-based Hybrid Particle Swarm Optimization and Genetic Algorithm. The method may obtain optimization results and is of higher optimization accuracy. In this method, update manners of position and speed in a standard particle swarm optimization are changed; a fitness function and a load balancing standard deviation are used to perform primary division and secondary division on particles in each generation of a particle swarm; a phagocytosis mechanism and a genetic algorithm are introduced; and phagocytosis mutation and crossover mutation are respectively performed on different particle subpopulations obtained after division.

To achieve the above purpose, the present invention provides the following technical solutions.

A cloud task scheduling method based on phagocytosis-based Hybrid Particle Swarm Optimization and Genetic Algorithm (HPSOGA) includes:

S1: encoding: using a real-number coding scheme, where each particle in a particle swarm represents a scheduling scheme, and a quantity of particle dimensions is equal to a quantity of missions;

S2: fitness calculation: using a fitness function to calculate a fitness value of each particle, and calculating an average fitness value of the particle swarm based on the fitness value of each particle;

S3: establishment of a feedback mechanism of a particle swarm optimization: establishing the feedback mechanism of the particle swarm optimization based on self-cognition and social cognition of the particle;

S4: division into particle subpopulations: respectively performing primary division and secondary division on each generation of the particle swarm by using the fitness function and a load balancing standard deviation, to form three particle subpopulations which are a phagocytic particle subpopulation, an ordinary particle subpopulation and a pathogen particle subpopulation, where a sum of quantities of particles in the three particle subpopulations formed after division is equal to a quantity of particles in the particle swarm before division;

S5: phagocytosis operation: performing phagocytosis operation on the phagocytic particle subpopulation and the pathogen particle subpopulation formed after division to obtain new particles, and placing the new particles into a next generation of a particle swarm;

S6: crossover operation: performing, according to in a genetic algorithm, crossover operation on the ordinary particle subpopulation formed after division to obtain new particles, and placing the new particles into a next generation of a particle swarm;

S7: combination of the particle subpopulations: combining the particles subjected to the phagocytosis operation and the crossover operation; and

S8: mutation operation: performing mutation operation on the particle swarm which is merged after the phagocytosis operation and crossover operation, updating an individual optimal solution and a global optimal solution of the particle swarm, and checking whether a maximum quantity of iterations is reached; if the maximum quantity of iterations is reached, the global optimal solution is a final cloud task scheduling scheme; and if the maximum quantity of iterations is not reached, the above steps are executed repeatedly.

Further, the fitness function in S2 is fitness=1/max(timeᵢ), and iϵ(0,1,2,3 . . . m−1), where timeᵢ represents time used to complete all cloud tasks run on a virtual machine i and m is a quantity of virtual machines.

Further, the establishment of a feedback mechanism of a particle swarm optimization in S3 specifically includes: when the quantity of particle dimensions and the quantity of cloud tasks are N,

S31: randomly generating a positive integer p, where a value range of p is [0, N−1], and p is used as a quantity of bits of the best position P_{best}_{_{L}} obtained by a particle L in each iteration process,

S32: randomly generating a positive integer y within the range of p, where a value range of y is [0, N−1], and y is used as a specific coding sequence subscript of the best position P_{best}_{_{L}} obtained by the particle L in each iteration,

S33: randomly generating a positive integer g, where a value range of g is [0, N−1], and g is used as a quantity of bits of the best position g_{best} which is currently searched by the particle swarm and obtained by the particle L in each iteration process, and

S34: randomly generating a positive integer z within the range of g, where a value range of z is [0, N−1], and z is used as a specific coding sequence subscript of the best position g_{best} which is currently searched by the particle swarm and obtained by the particle L in each iteration process.

Further, a calculation formula of the load balancing standard deviation in S4 is BL={square root over (Σᵢ₌₀^{m-1}(F(i)−AVL)²)}/m, F(i)=Σⱼ₌₁ⁿVLⱼⁱ, and AVL=Σᵢ₌₀^{m-1}F(i)/m, where BL is the load balancing standard deviation, F(i) is time used to complete all tasks allocated to the i^{th} virtual machine, m is a quantity of virtual machines, VLⁱⱼ represents time used to complete the j^{th} task allocated to the i^{th} virtual machine, n represents a total quantity of tasks allocated to the i^{th} virtual machine, and AVL is an average of a sum of the time used by all virtual machines to complete all tasks allocated thereto, which is also an average loading of virtual machines.

Further, the division into particle subpopulations in S4 specifically includes:

S41: dividing, based on the fitness value of each particle and the average fitness value of the particle swarm calculated in S2, a particle whose particle fitness value is greater than the average fitness value into an initial phagocytic particle subpopulation, and dividing a particle whose particle fitness value is smaller than the average fitness value into an initial pathogen particle subpopulation;

S42: using the calculation formula of load balancing standard deviation to calculate load balance standard deviations of particles in the two subpopulations after the primary division, and respectively calculating an average load balancing standard deviation of the two particle subpopulations;

S43: seperately comparing the load balancing standard deviation of each particle in the two subpopulations with the average load balancing standard deviation of the corresponding subpopulation;

S44: dividing a particle in the initial phagocytic particle subpopulation whose load balancing standard deviation is smaller than the average load balancing standard deviation of the initial phagocytic particle subpopulation into the ordinary particle subpopulation;

S45: dividing a particle in the initial pathogen particle subpopulation whose load balancing standard deviation is greater than the average load balancing standard deviation of the initial pathogen particle subpopulation into the ordinary particle subpopulation; and

S46: forming three particle subpopulations, which are respectively the phagocytic particle subpopulation, the ordinary particle subpopulation, and the pathogen particle subpopulation.

Further, the phagocytosis operation in S5 specifically includes:

S51: taking out a particle separately from the phagocytic particle subpopulation and the pathogen particle subpopulation, and segmenting coding sequences of the particles; and

S52: comparing, based on one of the two particles, a coding sequence fragment at a corresponding position of the other particle, phagocytizing a poor particle sequence fragment with low fitness by using an excellent particle sequence fragment with high fitness to finally obtain a new particle, which is put into the next generation of the particle swarm.

Further, the crossover operation in S6 uses two-point crossover, and right-left cross points are randomly selected.

Further, the combination of the particle subpopulations in S7 specifically comprises:

S71: making the particle swarm size be num, the phagocytic particle subpopulation size, the ordinary particle subpopulation size, and the pathogen particle subpopulation size after division in S4 respectively be phnum, cnum, and panum, the relationship therebetween being num=phnum+cnum+panum;

S72: if phnum≥panum, the next generation of the particle swarm is composed of panum new particles formed after the phagocytosis, phnum-panum particles in the phagocytic particle subpopulation that are not phagocytosed, new particles formed after the crossover operation and particles randomly generated when the particle swarm size is less than num; and

S73: if phnum<panum, the next generation of the particle swarm is composed of phnum particles formed after the phagocytosis, panum-phnum particles in the pathogen particle subpopulation that are not phagocytosed, particles formed after the crossover operation and particles randomly generated when the particle swarm size is less than num.

The present invention has the following beneficial effects.

The present invention proposes a phagocytosis-based Hybrid Particle Swarm Optimization and Genetic Algorithm (HPSOGA). In this algorithm, the fitness function and the load balancing standard deviation are used to perform the primary division and the secondary division on particles in each generation of the particle swarm; and crossover mutations of the phagocytosis mechanism and the genetic algorithm are introduced to respectively perform different operations on different particle subpopulations; and the positions of particles are changed. As a result, the diversity of particle swarms is ensured, a search range of an algorithm for solution space is expanded, and the possibility of the genetic algorithm falling into the local optimal solution is reduced. To sum up, the algorithm obviously reduces total completion time of cloud tasks and is of higher convergence accuracy.

### BRIEF DESCRIPTION OF THE DRAWINGS

FIG. 1 is a flowchart of a standard genetic algorithm according to the present invention;

FIG. 2 is a comparison histogram of task completion time of cloud task scheduling methods based on six algorithms in Embodiment 1 according to the present invention;

FIG. 3 is a comparison graph of task convergence accuracy of cloud task scheduling methods based on four algorithms in Embodiment 2 according to the present invention; and

FIG. 4 is a comparison graph of task convergence accuracy of cloud task scheduling methods based on five algorithms in Embodiment 3 according to the present invention.

### DETAILED DESCRIPTION

In order to enable those of ordinary skill in the art to better understand the technical solution of the present invention, the technical solution of the present invention will be further described in the following with reference to the accompanying drawings and embodiments.

Cloud computing task scheduling refers to mapping or allocating tasks to specific virtual machines. The objective of scheduling is to reasonably allocate required resources for cloud tasks submitted by cloud users to improve resource utilization. The scheduling result is generally reflected on the mapping relationships between tasks and virtual machines, that is, to determine which task runs on which virtual machine node. Due to the diversity of tasks and virtual machines, it is necessary to figure out how to allocate cloud tasks to virtual machines to obtain the shortest execution time. To be specific, for a given cloud task, we should find an appropriate virtual machine to ensure that the minimum value is obtained in task execution time (excluding time used to transmit data).

For convenience of simulation research, assumptions are proposed in the following.

(1) Ignore influence of factors such as bandwidth, data transmission, and communication time between virtual machines. Execution time of a task is equal to length of the task divided by execution speed of the virtual machine where the task is located.

(2) Abstract the task as a quantity of machine instructions, the unit is MI (million instructions) and the length is randomly selected within a specific range.

(3) All cloud computing resources are mapped to virtual machines, unit of virtual machine performance is MIPS (million instructions per second) and the virtual machine performance is selected within a specific range.

(4) Each task is independent of each other. When a plurality of tasks are allocated to a same virtual machine, the tasks are executed according to the “First In, First Out” principle.

(5) A quantity of submitted tasks is greater than or equal to a quantity of virtual machines.

Therefore, the cloud task scheduling problem can be described as: how to allocate N cloud tasks with different lengths to M virtual machines with different performance, to make total completion time of the N cloud tasks the shortest.

In 1995, Kennedy et al. proposed particle swarm optimization (PSO), which is originated from the simulation of migration and aggregation during foraging processes of birds and fish. In the particle swarm optimization, a population is called a swarm, and an individual is called a particle. Particles in the particle swarm optimization look for object through the search space like birds or fish look for food. Each particle has its own speed and position. In the movement, each particle adjusts its flight direction and speed based on its current position, speed, P_{best} and g_{best} to gradually approach the optimal solution, just as birds or fish look for food through collaboration and information sharing between particles in groups. The performance of each particle is measured by a fitness function. There are different fitness functions corresponding to different practical problems. Each particle is a candidate solution to the problem in research and has N dimensions determined by special problems. Position and speed of the particle are initialized randomly. Update manners of speed and positions of particles in each generation of the particle swarm are shown in v_{L}^{k+1}=wv_{L}^{k}+c₁r₁(p_{best}_{_{L}}−x_{L}^{k})+c₂r₂(g_{best}−x_{L}^{k}) and k_{L}^{k+1}=x_{L}^{k}+v_{L}^{k}.

v^{k} X^{k} represents the speed of a particle L at the k^{th} iteration, x_{L}^{k} represents the position of the particle L at the k^{th} iteration, V_{L}^{k+1} represents the speed of the particle L at the (k+1)^{th} iteration, x_{L}^{k+1} represents the position of the particle L at the (k+1)^{th} iteration, w represents an inertial weight, c₁ and c₂ represent acceleration factors, r₁ and r₂ indicate random number between [0, 1], p_{best}_{_{L}} represents the optimal position currently found by the particle L, and g_{best} indicates the optimal position found by the particle swarm.

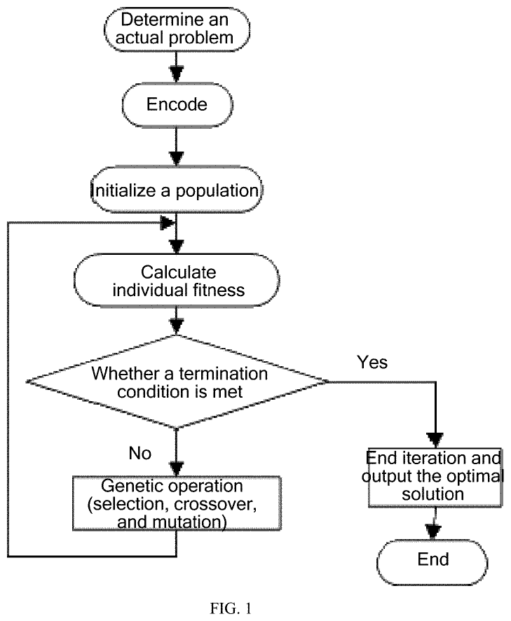

In 1975, Professor Holland first proposed the genetic algorithm in his book “Adaptation in Natural and Aritificial Systems”. The genetic algorithm is based on a mechanism of natural genetics, that is, a method such as genetic, selection, crossover and mutation, that drives biological evolution. Before searching, a potential solution of a problem is coded. The coding is a conversion method that converts a feasible solution of the problem from its solution space to the search space in which the genetic algorithm can handle. Coding maps the solution space to chromosome coding space, and different chromosome particles form a population. The algorithm starts with an initial random population of particles, and each particle represents a scheduling solution. In each generation of the population, a specific fitness function is used to calculate fitness of each particle in the population, which represents the particle's competitiveness. Through the genetic operations such as selection, crossover, and mutation, the population evolves to form a new generation of population. The evolved new generation of population calculates the fitness of the particle in the population again, and judges whether a termination condition is met. If the termination condition is met, a particle with the greatest fitness in the new generation of population is output as the optimal solution. If the termination condition is not met, the population continues to evolve through the genetic operations such as selection, crossover and mutation. FIG. 1 shows a flowchart of the standard genetic algorithm.

In the particle swarm optimization, the speed and position of the particle are updated based on the optimal position of the particle and the optimal position of global particle in each iteration. The optimal position of the particle corresponds to self-cognition of the particle, which is the flight experience of the particle. The optimal position of the global particle corresponds to the particle's cognition of the population, that is, social cognition, which is the flight experience of a particle companion. For each iteration, the particle swarm optimization will take these two experiences into account to form a feedback. In response to the task scheduling problem in cloud computing, if the standard particle swarm optimization is used, the particle speed cannot be effectively controlled, making it easy to enable the algorithm to fall into a local optimal solution, and the potential solution space cannot be effectively searched. As a result, the present invention introduces the phagocytosis mechanism and the crossover mutation operation of the genetic algorithm to improve the search capability of the particle swarm optimization for the solution space, avoiding a case in which the particle swarm optimization prematurely falls into the local optimal solution.

A cloud task scheduling method based on phagocytosis-based Hybrid Particle Swarm Optimization and Genetic Algorithm includes the following steps.

1. Particle encoding: use a real-number coding scheme, where each particle in a particle swarm represents a scheduling scheme, and a quantity of particle dimensions is equal to a quantity of missions.

Specifically, it is assumed that a quantity of tasks is N and a quantity of virtual machines is M. Number of each dimension of a particle represents number of a task, where a value range of the number is 0 to N−1. A positive integer value in each dimension represents number of the virtual machine, where a value range of the number is 0 to M−1. For example, when N=9, M=4, and a particle coding sequence is (2, 0, 0, 3, 1, 2, 1, 2, 3), it is indicated that the fourth and the ninth task is allocated to the fourth virtual machine; the first, the sixth, and the eighth tasks are allocated to the third virtual machine; the fifth and the seventh tasks are allocated to the second virtual machine; and the second and the third tasks are allocated to the first virtual machine.

2. Fitness calculation: use a fitness function to calculate a fitness value of each particle, and calculate an average fitness value of the particle swarm based on the fitness value of each particle.

Specifically, in the present invention, the shortest total completion time of a cloud task is taken as an objective. Therefore, the total completion time of the cloud task is taken as the fitness function. Less completion time of the cloud task indicates that the particle is better. As a result, the calculation formula of the fitness function is set to fitness=1/max(timeᵢ), and iϵ(0,1,2,3 . . . m−1), where timeᵢ represents the time used to complete all cloud tasks on a virtual machine i, and m is a quantity of virtual machines. The fitness of particles in the existing populations depends on the virtual machine that spends the most time completing all cloud tasks on it, and greater fitness value indicates less total time used to complete cloud tasks.

3. Establishment of a feedback mechanism of a particle swarm optimization: establish the feedback mechanism of the particle swarm optimization based on self-cognition and social cognition of the particle.

Specifically, in order to better apply the algorithm to task scheduling in cloud computing, the phagocytosis-based Hybrid Particle Swarm Optimization and Genetic Algorithm proposed in the present invention directly abandons the influence of speed on particle position, so that a case in which optimal value cannot be determined due to parameters such as inertial weights and acceleration factors can be avoided. However, the feedback mechanism in the standard particle swarm optimization is retained, and self-cognition and social cognition of the particle are considered.

When the quantity of particle dimensions, that is, the quantity of cloud tasks is N, the steps are specifically as follows.

S31. Randomly generate a positive integer p, where a value range of p is [0, N−1], and p is used as a quantity of bits of the best position p_{best}_{_{L}} obtained by a particle L in each iteration process.

S32. Randomly generate a positive integer y within the range of p, where a value range of y is [0, N−1], and y is used as a specific coding sequence subscript of the best position p_{best}_{_{L}} obtained by the particle L in each iteration.

S33. Randomly generate a positive integer g, where a value range of g is [0, N−1], and g is used as a quantity of bits of the best position g_{best} which is currently searched by the particle swarm and obtained by the particle L in each iteration process.

S34. Randomly generate a positive integer z within the range of g, where a value range of z is [0, N−1], and z is used as a specific coding sequence subscript of the best position g_{best} which is currently searched by the particle swarm and obtained by the particle L in each iteration process.

4. Division into particle subpopulations: respectively perform primary division and secondary division on each generation of the particle swarm by using the fitness function and a load balancing standard deviation, to form three particle subpopulations which are a phagocytic particle subpopulation, an ordinary particle subpopulation and a pathogen particle subpopulation.

Specifically, a calculation formula of the load balancing standard deviation is BL={square root over (Σᵢ₌₀^{m-1}(F(i)−AVL)²)}/m, F(i)=Σⱼ₌₁ⁿVLᵢ^{j}, AVL=Σᵢ₌₀^{m-1}F(i)/m where BL is the load balancing standard deviation, F(i) is time used to complete all tasks allocated to the i^{th} virtual machine, m is a quantity of virtual machines, AVL is an average of a sum of the time used by all virtual machines to complete all tasks allocated thereto, which is also an average loading of virtual machines, VLⁱⱼ represents time used to complete the j^{th} task allocated to the i^{th} virtual machine, and n represents a total quantity of tasks allocated to the i^{th} virtual machine.

Further, the specific steps of division into particle subpopulations are as follows.

S41. Divide, based on the fitness value of each particle and the average fitness value of the particle swarm calculated in S2, a particle whose particle fitness value is greater than the average fitness value into an initial phagocytic particle subpopulation, and divide a particle whose particle fitness value is smaller than the average fitness value into an initial pathogen particle subpopulation.

S42. Use the calculation formula of load balancing standard deviation to calculate load balance standard deviations of particles in the two subpopulations after the primary division, and respectively calculate an average load balancing standard deviation of the two particle subpopulations.

S43. Separately compare the load balancing standard deviation of each particle in the two subpopulations with the average load balancing standard deviations of the corresponding subpopulation. S44. Divide a particle in the initial phagocytic particle subpopulation whose load balancing standard deviation is smaller than the average load balancing standard deviation of the initial phagocytic particle subpopulation into the ordinary particle subpopulation.

S45. Divide a particle in the initial pathogen particle subpopulation whose load balancing standard deviation is greater than the average load balancing standard deviation of the initial pathogen particle subpopulation into the ordinary particle subpopulation.

S46. Form three particle subpopulations, which are respectively the phagocytic particle subpopulation, the ordinary particle subpopulation, and the pathogen particle subpopulation.

5. Phagocytosis operation: perform the phagocytosis operation on the phagocytic particle subpopulation and the pathogen particle subpopulation formed after division.

Specifically, take out a particle separately from the phagocytic particle subpopulation and the pathogen particle subpopulation, and segment coding sequences of the particles.

Compare, based on one of the two particles, a coding sequence fragment at a corresponding position of the other particle, phagocytize a poor particle sequence fragment with low fitness by using an excellent particle sequence fragment with high fitness to finally obtain a new particle, which is taken as a collection of an excellent coding sequence fragment of a phagocytosic particle and an excellent coding sequence fragment of a pathogen particle and is put into the next generation of the particle swarm.

6. Crossover operation: perform, according to in a genetic algorithm, crossover operation on the ordinary particle subpopulation formed after division, where the crossover operation uses two-point crossover, and right-left cross points are randomly selected.

Specifically, two particles are selected from the ordinary particle subpopulation as a parent particle of the crossover operation. Two crossover positions are randomly selected in the particles' coding sequences or according to a specific rule. These two crossover positions are used to form a crossover domain. Parent particles exchange coding sequences in the crossover domain to generate new generations of offspring particles.

7. Combination of the particle subpopulations: combine the particles subjected to the phagocytosis operation and the crossover operation.

Specifically, make the particle swarm size be num, the phagocytic particle subpopulation size, the ordinary particle subpopulation size, and the pathogen particle subpopulation size after division in S4 respectively be phnum, cnum, and panum, so that the relationship therebetween being num=phnum+cnum+panum.

If phnum≥panum, the new particle swarm is composed of panum new particles formed after the phagocytosis, phnum-panum particles in the phagocytic particle subpopulation that are not phagocytosed, particles formed after the crossover operation and particles randomly generated when the particle swarm size is less than num.

If phnum<panum, the new particle swarm is composed of phnum particles formed after the phagocytosis, panum-phnum particles in the pathogen particle subpopulation that are not phagocytosed, particles formed after the crossover operation and particles randomly generated when the particle swarm size is less than num.

8. Mutation operation: perform the mutation operation on the particle swarm that is combined again after the phagocytosis operation and the crossover operation. The mutation operation uses simple mutation, and genes on chromosome change in a predetermined probability, and the final cloud task scheduling scheme is obtained.

Specifically, change one bit or some bits of a particle coding sequence in the predetermined mutation probability within a randomly specified range, then update an individual optimal solution and a global optimal solution of the particle swarm, and check whether a maximum quantity of iterations is reached; if the maximum quantity of iterations is reached, the global optimal solution is a final cloud task scheduling scheme; and if the maximum quantity of iterations is not reached, the above steps are executed repeatedly. The maximum quantity of iterations is manually set according to needs in advance.

In order to verify the effectiveness of the phagocytosis-based Hybrid Particle Swarm Optimization and Genetic Algorithm (HPSOGA) proposed in the present invention, the following embodiments are carried out.

### Embodiment 1

When the quantities of tasks are different, the cloud task scheduling method based on phagocytosis-based Hybrid Particle Swarm Optimization and Genetic Algorithm (HPSOGA) provided in the present invention is compared with the particle swarm optimization (PSO), the First In, First Out (FIFO) scheduling strategy, the improved particle swarm optimization (PSO_CM), the hybrid of enhanced particle swarm optimization and genetic algorithm (GA_EPSO) and the improved genetic algorithm (IGA) in terms of the task completion time when cloud task scheduling is performed.

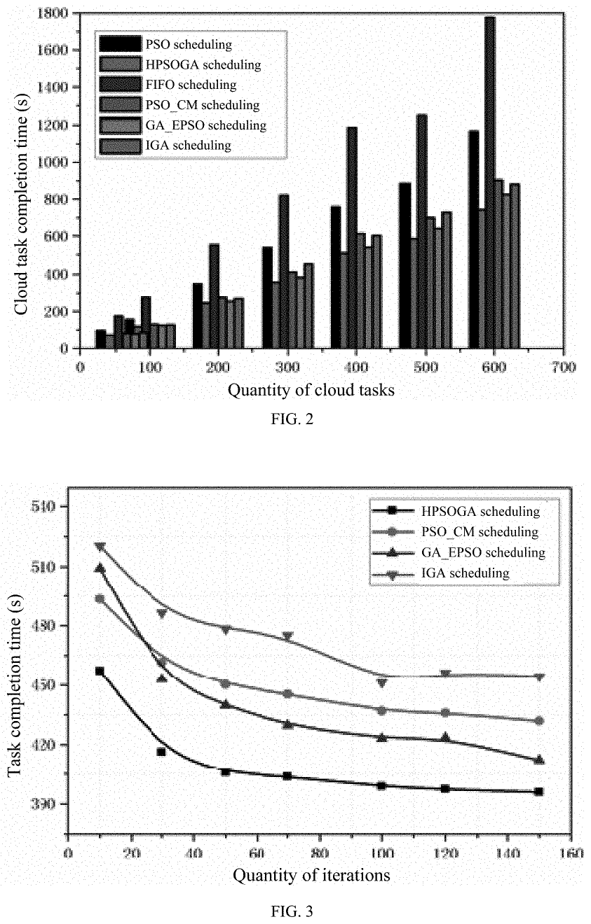

10 virtual machines are used and the quantity of virtual machines remains unchanged. The quantity of tasks ranges from 60 to 600. The quantity of iterations of each algorithm is the same and remains unchanged. Calculations are repeated for a plurality of times and the average value is taken to verify the performance of the phagocytosis-based HPSOGA algorithm in terms of task completion time. Specific algorithm parameter settings are shown in Table 1, and the results are shown in FIG. 2.

TABLE 1
Phagocytosis-based HPSOGA scheduling parameter table

| Algorithm | Parameter | Value |
|---|---|---|
| Phagocytosis-based | Size of Particle Swarm | 100 |
| HPSOGA scheduling | Quantity of Virtual Machines | 10 |
| | Maximum Quantity of Iterations | 150 |
| | Crossover Probability | 1 |
| | Mutation Probability | 0.05 |
| | Quantity of particle fragments | 10 |
| | Quantity of tasks | 60-600 |

It can be seen from FIG. 2 that the quantity of cloud tasks ranges from 60 to 600. The cloud task completion time of the phagocytosis-based HPSOGA algorithm has shorter cloud task completion time than other algorithms. Compared with the PSO scheduling and the FIFO scheduling, the task completion time is obviously shortened. When the quantity of cloud tasks ranges from 60 to 200, compared with the PSO_CM scheduling, the GA_EPSO scheduling, and the IGA scheduling, the performance of the phagocytosis-based HPSOGA scheduling algorithm improves, albeit not obviously. However, as the quantity of cloud tasks increases, compared with these three algorithms, the phagocytosis-based HPSOGA algorithm greatly shortens the cloud task completion time.

### Embodiment 2

When the batch of tasks, the quantity of tasks are the same, and the quantity of times of iterations are different, the cloud task scheduling method based on phagocytosis-based HPSOGA provided in the present invention is compared with the improved particle swarm optimization (PSO_CM), the hybrid of enhanced particle swarm optimization and genetic algorithm (GA_EPSO) and the improved genetic algorithm (IGA) to verify the convergence accuracy of the cloud task scheduling method provided in the present invention.

10 virtual machines are used, the quantity of cloud tasks is 300 and the tasks are of the same batch of cloud tasks. The quantity of virtual machines and the quantity of cloud tasks remain unchanged, and the quantity of iterations of the algorithm is changed. Calculations are repeated for a plurality of times and the average value is taken to verify the performance of the phagocytosis-based HPSOGA algorithm in terms of convergence accuracy. The specific algorithm parameters are the same as those in Embodiment 1, and the results are shown in FIG. 3.

### Embodiment 3

When the quantity of cloud tasks remains unchanged and the tasks are of different batches, the cloud task scheduling method based on phagocytosis-based HPSOGA provided in the present invention is compared with the particle swarm optimization (PSO), the improved particle swarm optimization (PSO_CM), the hybrid of enhanced particle swarm optimization and genetic algorithm (GA_EPSO) and the improved genetic algorithm (IGA) to verify the convergence accuracy of the cloud task scheduling method provided in the present invention.

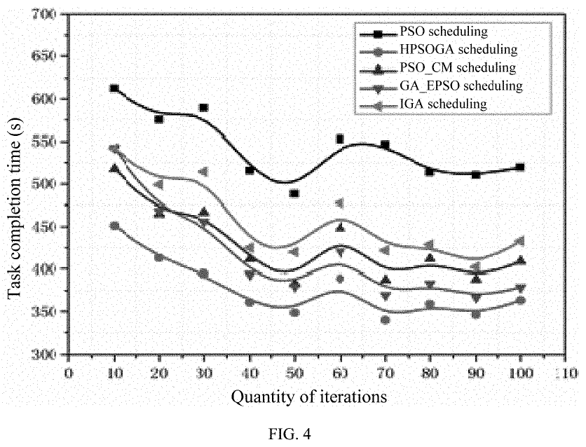

10 virtual machines are used, and the quantity of cloud tasks is 300. When the quantity of cloud tasks remains unchanged and the batch of the tasks are different, the quantity of iterations of the algorithm is changed and calculations are repeated for a plurality of times and the average value is taken to verify the performance of the phagocytosis-based HPSOGA algorithm in terms of convergence accuracy. The specific algorithm parameters are the same as those in Embodiment 1, and the results are shown in FIG. 4.

It can be seen from FIG. 3 that when 300 cloud tasks are of the same batch, the quantity of iterations of the algorithm is changed. When the quantity of iterations ranges from 10 to 40, as the quantity of iterations increases, the cloud task completion time of the phagocytosis-based HPSOGA algorithm shortens rapidly. When the quantity of iterations reaches 50, the cloud task completion time tends to be stable. When the quantity of iterations ranges from 50 to 150, the task completion time is shortened, albeit not obviously. To sum up, the phagocytosis-based HPSOGA algorithm can converge to the global optimal solution faster than other algorithms in Embodiment 2, and can find a better global optimal solution.

It can be seen from FIG. 4 that when only the quantity of cloud tasks remains unchanged while the scheduling task is different in each experiment, the scheduling curve of the phagocytosis-based HPSOGA algorithm is relatively smoother than the scheduling curves of other algorithms in FIG. 4, that is, stability of the phagocytosis-based HPSOGA algorithm is better than that of other algorithms compared in Embodiment 3.

Therefore, it can be seen from FIG. 3 and FIG. 4 that when the quantity of cloud tasks remains unchanged and the quantity of iterations are different, the phagocytosis-based HPSOGA algorithm is superior to other existing algorithms in comparison and has higher convergence accuracy.

The basic principles, main features, and advantages of the present invention are shown and described above. It should be understood by those skilled in the art that, the present invention is not limited by the aforementioned examples. The aforementioned examples and the description only illustrate the principle of the present invention. Various changes and modifications may be made to the present invention without departing from the spirit and scope of the present invention. Such changes and modifications all fall within the claimed scope of the present invention. The protection scope of the present invention is defined by the appended claims and their equivalents.

What is claimed is:

1. A cloud task scheduling method based on phagocytosis-based Hybrid Particle Swarm Optimization and Genetic Algorithm (HPSOGA), wherein the method comprises:
S1: encoding: using a real-number coding scheme, wherein each particle in a particle swarm represents a scheduling scheme, and a quantity of particle dimensions is equal to a quantity of missions;
S2: fitness calculation: using a fitness function to calculate a fitness value of each particle, and calculating an average fitness value of the particle swarm based on the fitness value of each particle;
S3: establishment of a feedback mechanism of a particle swarm optimization: establishing the feedback mechanism of the particle swarm optimization based on self-cognition and social cognition of the particle;
S4: division into particle subpopulations: respectively performing primary division and secondary division on each generation of the particle swarm by using the fitness function and a load balancing standard deviation, to form three particle subpopulations which are a phagocytic particle subpopulation, an ordinary particle subpopulation and a pathogen particle subpopulation, wherein a sum of quantities of particles in the three particle subpopulations formed after division is equal to a quantity of particles in the particle swarm before division;
S5: phagocytosis operation: performing phagocytosis operation on the phagocytic particle subpopulation and the pathogen particle subpopulation formed after division to obtain new particles, and placing the new particles into a next generation of a particle swarm;
S6: crossover operation: performing, according to in a genetic algorithm, crossover operation on the ordinary particle subpopulation formed after division to obtain new particles, and placing the new particles into a next generation of a particle swarm;
S7: combination of the particle subpopulations: combining the particles subjected to the phagocytosis operation and the crossover operation; and
S8: mutation operation: performing mutation operation on the particle swarm which is merged after the phagocytosis operation and crossover operation, updating an individual optimal solution and a global optimal solution of the particle swarm, and checking whether a maximum quantity of iterations is reached; if the maximum quantity of iterations is reached, the global optimal solution is a final cloud task scheduling scheme; and if the maximum quantity of iterations is not reached, the above steps are executed repeatedly.

2. The cloud task scheduling method based on phagocytosis-based HPSOGA according to claim 1, wherein the fitness function in S2 is fitness=1/max(timeᵢ), and iϵ(0,1,2,3 . . . m−1), wherein timeᵢ represents time used to complete all cloud tasks run on a virtual machine i and m is a quantity of virtual machines.

3. The cloud task scheduling method based on phagocytosis-based HPSOGA according to claim 2, wherein the establishment of a feedback mechanism of a particle swarm optimization in S3 specifically comprises: when the quantity of particle dimensions and the quantity of cloud tasks are N,
S31: randomly generating a positive integer p, wherein a value range of p is [0, N−1], and p is used as a quantity of bits of the best position P_{best}_{_{L}} obtained by a particle L in each iteration process,
S32: randomly generating a positive integer y within the range of p, wherein a value range of y is [0, N−1], and y is used as a specific coding sequence subscript of the best position best P_{best}_{_{L}} obtained by the particle L in each iteration,
S33: randomly generating a positive integer g, wherein a value range of g is [0, N−1], and g is used as a quantity of bits of the best position g_{best} which is currently searched by the particle swarm and obtained by the particle L in each iteration process, and
S34: randomly generating a positive integer z within the range of g, wherein a value range of z is [0, N−1], and z is used as a specific coding sequence subscript of the best position g_{best} which is currently searched by the particle swarm and obtained by the particle L in each iteration process.

4. The cloud task scheduling method based on phagocytosis-based HPSOGA according to claim 3, wherein a calculation formula of the load balancing standard deviation in S4 is BL={square root over (Σᵢ₌₀^{m-1}(F(i)−AVL)²)}/m, F(i)=Σⱼ₌₁ⁿVLⱼⁱ, and AVL=Σᵢ₌₀^{m-1}F(i)/m, wherein BL is the load balancing standard deviation, F(i) is time used to complete all tasks allocated to the i^{th} virtual machine, m is a quantity of virtual machines, VLⱼⁱ represents time used to complete the j^{th} task allocated to the i^{th} virtual machine, n represents a total quantity of tasks allocated to the i^{th} virtual machine, and AVL is an average of a sum of the time used by all virtual machines to complete all tasks allocated thereto, which is also an average loading of virtual machines.

5. The cloud task scheduling method based on phagocytosis-based HPSOGA according to claim 4, wherein the division into particle subpopulations in S4 specifically comprises:
S41: dividing, based on the fitness value of each particle and the average fitness value of the particle swarm calculated in S2, a particle whose particle fitness value is greater than the average fitness value into an initial phagocytic particle subpopulation, and dividing a particle whose particle fitness value is smaller than the average fitness value into an initial pathogen particle subpopulation;
S42: using the calculation formula of load balancing standard deviation to calculate load balance standard deviations of particles in the two subpopulations after the primary division, and respectively calculating an average load balancing standard deviation of the two particle subpopulations;
S43: seperately comparing the load balancing standard deviation of each particle in the two subpopulations with the average load balancing standard deviation of the corresponding subpopulation;
S44: dividing a particle in the initial phagocytic particle subpopulation whose load balancing standard deviation is smaller than the average load balancing standard deviation of the initial phagocytic particle subpopulation into the ordinary particle subpopulation;
S45: dividing a particle in the initial pathogen particle subpopulation whose load balancing standard deviation is greater than the average load balancing standard deviation of the initial pathogen particle subpopulation into the ordinary particle subpopulation; and
S46: forming three particle subpopulations, which are respectively the phagocytic particle subpopulation, the ordinary particle subpopulation, and the pathogen particle subpopulation.

6. The cloud task scheduling method based on phagocytosis-based HPSOGA according to claim 5, wherein the phagocytosis operation in S5 specifically comprises:
S51: taking out a particle separately from the phagocytic particle subpopulation and the pathogen particle subpopulation, and segmenting coding sequences of the particles; and
S52: comparing, based on one of the two particles, a coding sequence fragment at a corresponding position of the other particle, phagocytizing a poor particle sequence fragment with low fitness by using an excellent particle sequence fragment with high fitness to finally obtain a new particle, which is put into the next generation of the particle swarm.

7. The cloud task scheduling method based on phagocytosis-based HPSOGA according to claim 6, wherein the crossover operation in S6 uses two-point crossover, and right-left cross points are randomly selected.

8. The cloud task scheduling method based on phagocytosis-based HPSOGA according to claim 7, wherein the combination of the particle subpopulations in S7 specifically comprises:
S71: making the particle swarm size be num, the phagocytic particle subpopulation size, the ordinary particle subpopulation size, and the pathogen particle subpopulation size after division in S4 respectively be phnum, cnum, and panum, the relationship therebetween being num=phnum+cnum+panum;
S72: if phnum≥panum, the next generation of the particle swarm is composed of panum new particles formed after the phagocytosis, phnum-panum particles in the phagocytic particle subpopulation that are not phagocytosed, new particles formed after the crossover operation and particles randomly generated when the particle swarm size is less than num; and
S73: if phnum<panum, the next generation of the particle swarm is composed of phnum particles formed after the phagocytosis, panum-phnum particles in the pathogen particle subpopulation that are not phagocytosed, particles formed after the crossover operation and particles randomly generated when the particle swarm size is less than num.
